(19) United States
(12) Patent Application Publication
(10) Pub. No.: US 2009/0112355 A1
(43) Pub. Date: Apr. 30, 2009

(54) Device and Method for Dressing Cutting Tools

(75) Inventors: Gregory Hyatt, South Barrington, IL (US); Koji Okura, Nara-City (JP); Nitin Chaphalkar, Mount Prospect, IL (US)

Correspondence Address: BANNER & WITCOFF, LTD., TEN SOUTH WACKER DRIVE, SUITE 3000, CHICAGO, IL, 60606, US

(73) Assignee: Mori Seiki USA, Inc., Rolling Meadows, IL (US)

(21) Appl. No.: 12/040,528

(22) Filed: Feb. 29, 2008

Related U.S. Application Data
(60) Provisional application No. 60/892,771, filed on Mar. 2, 2007.

(51) Int. Cl. G05B 19/19

(52) U.S. Cl. 700/164

(57) ABSTRACT

Disclosed are a computer numerically controlled machine and methods for forming, grinding, or dressing cutting tools in a computer numerically controlled machine. In some embodiments, the computer numerically controlled machine is provided with a cutting tool and an abrasive surface. The abrasive surface is brought into contact with the cutting tool to abrade material from the cutting tool in a grinding or dressing operation. In certain embodiments, it is not necessary to remove the cutting tool from the computer numerically controlled machine for dressing. In some non-mutually-exclusive embodiments, the machine is provided with tool blanks, from which cutting tools are prepared using an abrasive surface in the machine.

### RELATED APPLICATION

This application claims the benefit of prior provisional application Ser. No. 60/892,771 filed Mar. 2, 2007. The entire contents of the prior provisional application are hereby incorporated by reference.

### TECHNICAL FIELD OF THE INVENTION

The present invention is in the field of machine tools, in particular computer numerically controlled machine tools.

### BACKGROUND OF THE INVENTION

Computer numerically controlled machines are used with cutting tools in various operations such as turning, boring, drilling, broaching, and milling. Typically, a cutting tool must be removed from the machine for grinding or dressing. In conventional machines, the cutting tool is sent to a separate grinding or dressing station, and a new cutting tool is inserted into the machine.

This typical approach suffers from a number of drawbacks. Typically, the quality of the work is the best when the cutting tool is new. As the tool is used, it degrades, and the quality of work produced by the cutting tool deteriorates. Additionally, the machine tool operator must stock a supply of several identical cutting tools to use while other tools are being dressed or ground, particularly if the tool dressing station is off-site.

### SUMMARY OF THE INVENTION

The present invention provides in some embodiments, a method for grinding or dressing a cutting tool in a machine without the necessity of removing the tool from the machine or tool holder in which it is used. An abrasive surface, such as a grinding or dressing wheel, is provided in the machine. In accordance with some embodiments, the wheel is mounted on a turret or chuck of the machine. The abrasive surface is brought into contact with the tool and, in accordance with the programming of the machine, is moved relative to the tool to dress or grind the tool.

In preferred embodiments, numerous advantages are afforded. Variability in profile and surface texture of work machine may be improved, with resultant improvement in deflection or deformation of the work. The tool may be ground or dressed frequently with little operational downtime. If desired, the tool may be dressed after each tool operation.

Additionally, in some embodiments the provision of an abrasive surface in the machine allows the formation of tools in the machine. A tool blank may be provided, and the grinding wheel may be used to create tools per appropriate machine programming.

### DESCRIPTION OF THE FIGURES

FIG. 1 is a front elevation view of a computer numerically controlled machine in accordance with one embodiment of the present invention, shown with safety doors closed;

FIG. 2 is a front elevation view of a computer numerically controlled machine illustrated in FIG. 1, shown with the safety doors open;

FIG. 3 is a perspective view of certain interior components of the computer numerically controlled machine illustrated in FIGS. 1 and 2, depicting a machining spindle, a first chuck, a second chuck, and a turret;

FIG. 4 a perspective view, enlarged with respect to FIG. 3 illustrating the machining spindle and the horizontally and vertically disposed rails via which the spindle may be translated;

FIG. 5 is a side view of the first chuck, machining spindle, and turret of the machining center illustrated in FIG. 1;

FIG. 6 is a view similar to FIG. 5 but in which a machining spindle has been translated in the Y-axis;

FIG. 7 is a front view of the spindle, first chuck, and second chuck of the computer numerically controlled machine illustrated in FIG. 1, including a line depicting the permitted path of rotational movement of this spindle;

FIG. 8 is a perspective view of the second chuck illustrated in FIG. 3, enlarged with respect to FIG. 3;

FIG. 9 is a perspective view of the first chuck and turret illustrated in FIG. 2, depicting movement of the turret and turret stock in the Z-axis relative to the position of the turret in FIG. 2;

FIG. 10 illustrates a grinding or dressing operation of a cutting tool disposed on a spindle;

FIG. 11 is a representation of a dressing or grinding operation performed on a polygonal boring reinsert;

FIG. 12 is an exploded view of a chuck of the computer numerically controlled machine, the chuck including a generally annular abrasive surface disposed thereon, and further depicting a grinding or dressing operation;

FIG. 13 is a view representing a grinding wheel having a generally cylindrical form and depicting reduction in size from a first diameter to a second diameter;

FIG. 14 is a representation of a grinding operation for a cutting tool;

FIGS. 15 and 16 illustrate different steps in a grinding operation for a cutting tool in a computer numerically controlled machine;

FIG. 17 is a representation of an alternative grinding operation in a computer numerically controlled machine;

FIG. 18 is a perspective view of one embodiment of a tool blank useful in conjunction with certain embodiments of the invention;

FIGS. 18a-18c are perspective views of alternative forms of cutting tools that may be prepared using the tool blank depicted in FIG. 18; and

FIG. 19 is a representation of a regrinding or dressing operation for a gun-style drill.

The Figures are not intended to be scale figures.

### DETAILED DESCRIPTION

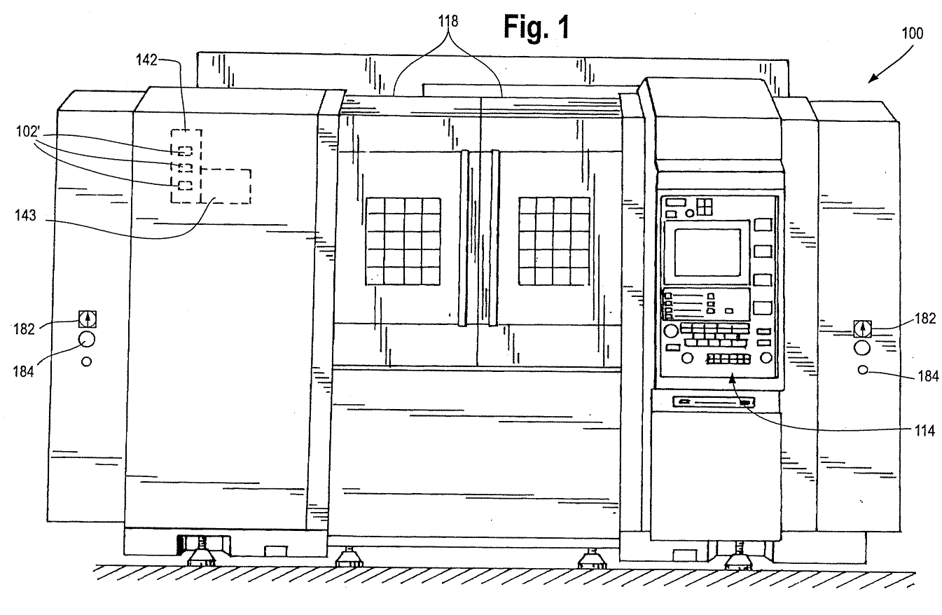

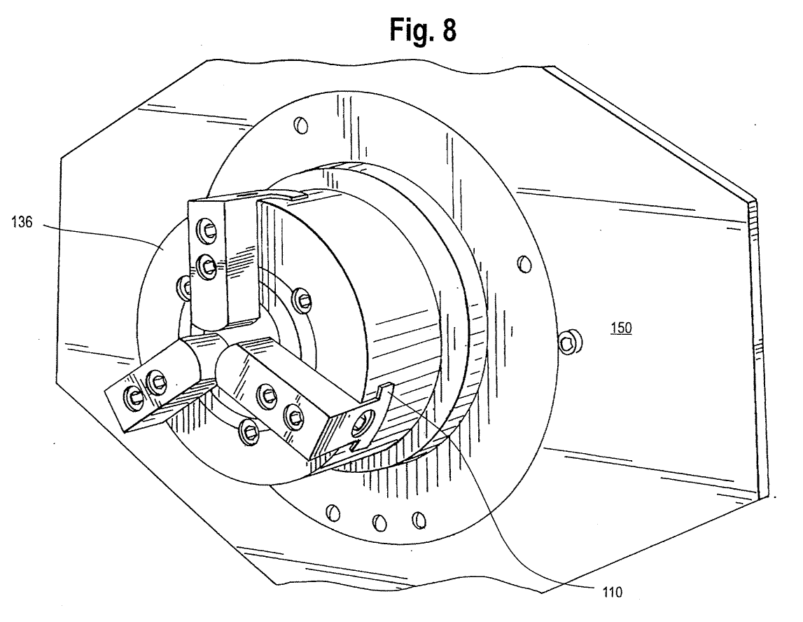

Any suitable apparatus may be employed in conjunction with the methods of invention. In some embodiments, the methods are performed using a computer numerically controlled machine, illustrated generally in FIGS. 1-9. A computer numerically controlled machine is itself provided in other embodiments of the invention. The machine 100 illustrated in FIGS. 1-9 is an NT-series machine, versions of which are available from Mori Seiki USA, Inc., the assignee of the present application. Other suitable computer numerically controlled machines include the NL-series machines with turret (not shown), also available from Mori Seiki USA, Inc. Other machines may be used in conjunction with the invention, including the NZ, NH, NV, and NMV machines, also available from Mori Seiki USA, Inc.

In general, with reference to the NT-series machine illustrated in FIGS. 1-3, one suitable computer numerically controlled machine 100 has at least a first retainer and a second retainer, each of which may be one of a spindle retainer associated with spindle 144, a turret retainer associated with a turret 108, or a chuck 110, 112. In the embodiment illustrated in the Figures, the computer numerically controlled machine 100 is provided with a spindle 144, a turret 108, a first chuck 110, and a second chuck 112. The computer numerically controlled machine 100 also has a computer control system operatively coupled to the first retainer and to the second retainer for controlling the retainers, as described in more detail below. It is understood that in some embodiments, the computer numerically controlled machine 100 may not contain all of the above components, and in other embodiments, the computer numerically controlled machine 100 may contain additional components beyond those designated herein.

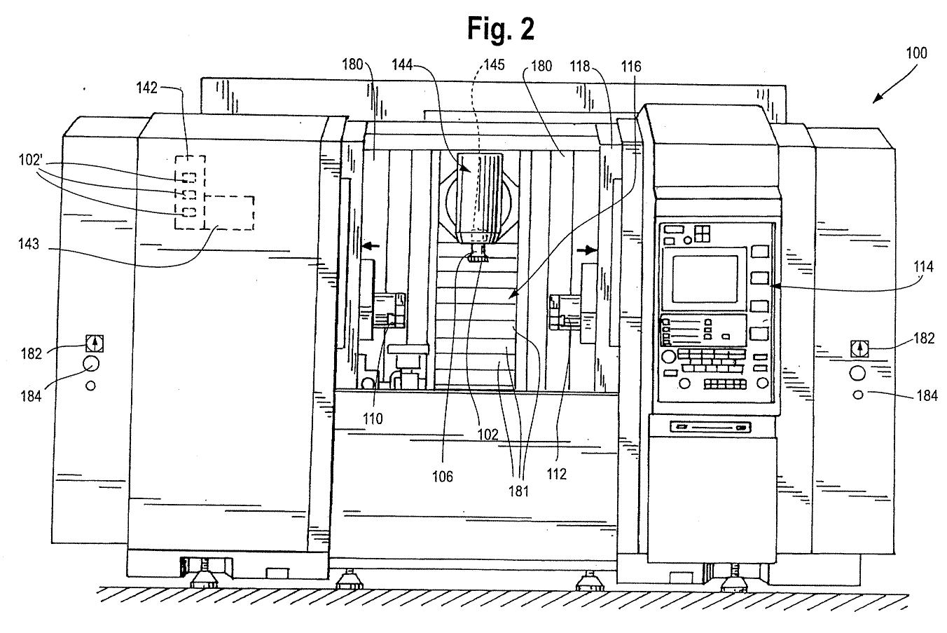

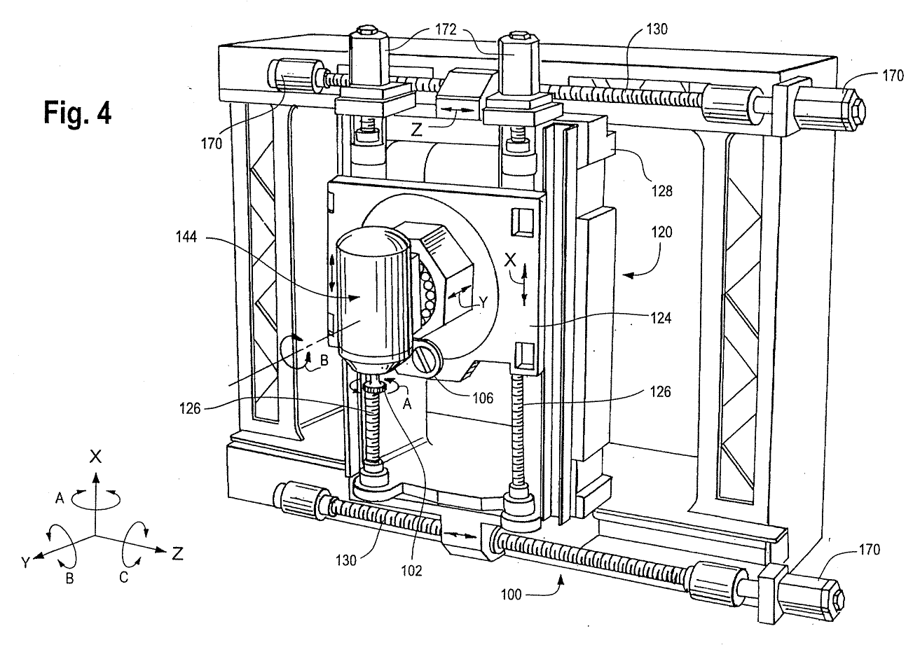

As shown in FIGS. 1 and 2, the computer numerically controlled machine 100 has a machine chamber 116 in which various operations generally take place upon a workpiece (not shown). Each of the spindle 144, the turret 108, the first chuck 110, and the second chuck 112 may be completely or partially located within the machine chamber 116. In the embodiment shown, two moveable safety doors 118 separate the user from the chamber 116 to prevent injury to the user or interference in the operation of the computer numerically controlled machine 100. The safety doors 118 can be opened to permit access to the chamber 116 as illustrated in FIG. 2. The computer numerically controlled machine 100 is described herein with respect to three orthogonally oriented linear axes (X, Y, and Z), depicted in FIG. 4 and described in greater detail below. Rotational axes about the X, Y and Z axes are connoted “A,” “B,” and “C” rotational axes respectively.

The computer numerically controlled machine 100 is provided with a computer control system for controlling the various instrumentalities within the computer numerically controlled machine. In the illustrated embodiment, the machine is provided with two interlinked computer systems, a first computer system comprising a user interface system (shown generally at 114 in FIG. 1) and a second computer system (not illustrated) operatively connected to the first computer system. The second computer system directly controls the operations of the spindle, the turret, and the other instrumentalities of the machine, while the user interface system 114 allows an operator to control the second computer system. Collectively, the machine control system and the user interface system, together with the various mechanisms for control of operations in the machine, may be considered a single computer control system. In some embodiments, the user operates the user interface system to impart programming to the machine; in other embodiments, programs can be loaded or transferred into the machine via external sources. It is contemplated, for instance, that programs may be loaded via a PCMCIA interface, an RS-232 interface, a universal serial bus interface (USB), or a network interface, in particular a TCP/IP network interface. In other embodiments, a machine may be controlled via conventional PLC (programmable logic controller) mechanisms (not illustrated).

As further illustrated in FIGS. 1 and 2, the computer numerically computer controlled machine 100 may have a tool magazine 142 and a tool changing device 143. These cooperate with the spindle 144 to permit the spindle to operate with plural cutting tools (shown in FIG. 1 as tools 102′). Generally, a variety of cutting tools may be provided; in some embodiments, plural tools of the same type may be provided.

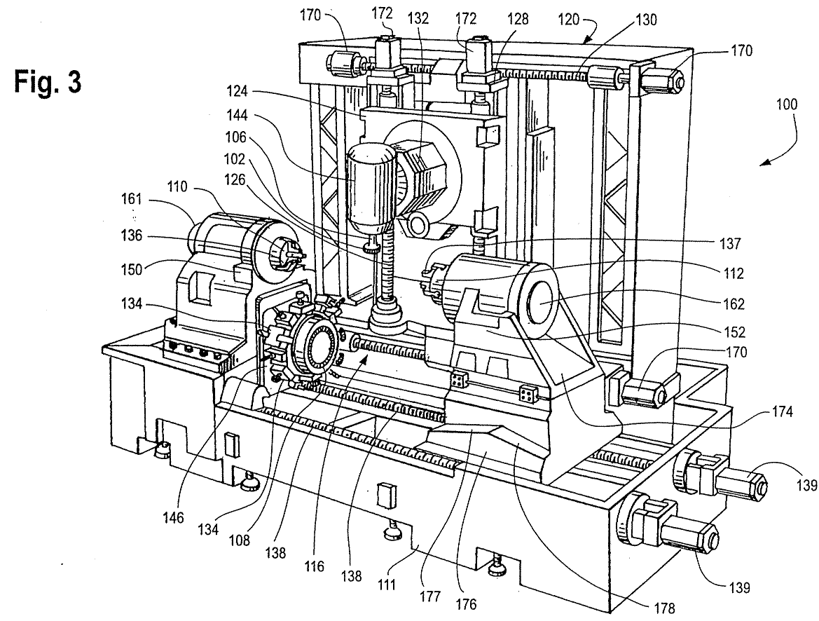

The spindle 144 is mounted on a carriage assembly 120 that allows for translational movement along the X- and Z-axes, and on a ram 132 that allows the spindle 144 to be moved in the Y-axis. The ram 132 is equipped with a motor to allow rotation of the spindle in the B-axis, as set forth in more detail hereinbelow. As illustrated, the carriage assembly has a first carriage 124 that rides along two threaded vertical rails (one rail shown at 126) to cause the first carriage 124 and spindle 144 to translate in the X-axis. The carriage assembly also includes a second carriage 128 that rides along two horizontally disposed threaded rails (one shown in FIG. 3 at 130) to allow movement of the second carriage 128 and spindle 144 in the Z-axis. Each carriage 124, 128 engages the rails via plural ball screw devices whereby rotation of the rails 126, 130 causes translation of the carriage in the X- or Z-direction respectively. The rails are equipped with motors 170 and 172 for the horizontally disposed and vertically disposed rails respectively.

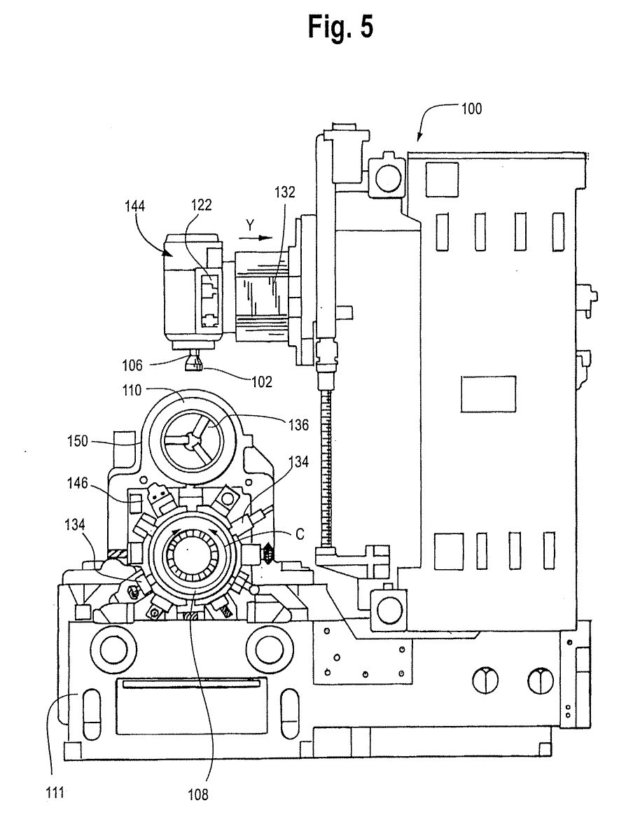

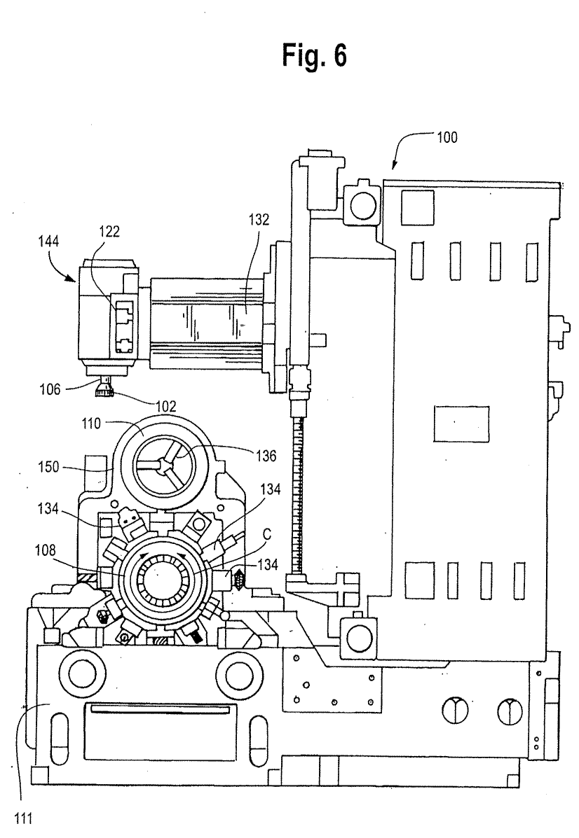

The spindle 144 holds the cutting tool 102 by way of a spindle connection and a tool holder 106. The spindle connection 145 (shown in FIG. 2) is connected to the spindle 144 and is contained within the spindle 144. The tool holder 106 is connected to the spindle connection 145 and holds the cutting tool 102. Various types of spindle connections are known in the art and can be used with the computer numerically controlled machine 100. Typically, the spindle connection 145 is contained within the spindle 144 for the life of the spindle. An access plate 122 for the spindle 144 is shown in FIGS. 5 and 6.

The first chuck 110 is provided with jaws 136 and is disposed in a stock 150 that is stationary with respect to the base 111 of the computer numerically controlled machine 100. The second chuck 112 is also provided with jaws 137, but the second chuck 112 is movable with respect to the base 111 of the computer numerically controlled machine 100. More specifically, the machine 100 is provided with threaded rails 138 and motors 139 for causing translation in the Z-direction of the second stock 152 via a ball screw mechanism as heretofore described. To assist in swarf removal, the stock 152 is provided with a sloped distal surface 174 and a side frame 176 with Z-sloped surfaces 177, 178. Hydraulic controls and associated indicators for the chucks 110, 112 may be provided, such as the pressure gauges 182 and control knobs 184 shown in FIGS. 1 and 2. Each stock is provided with a motor (161, 162 respectively) for causing rotation of the chuck.

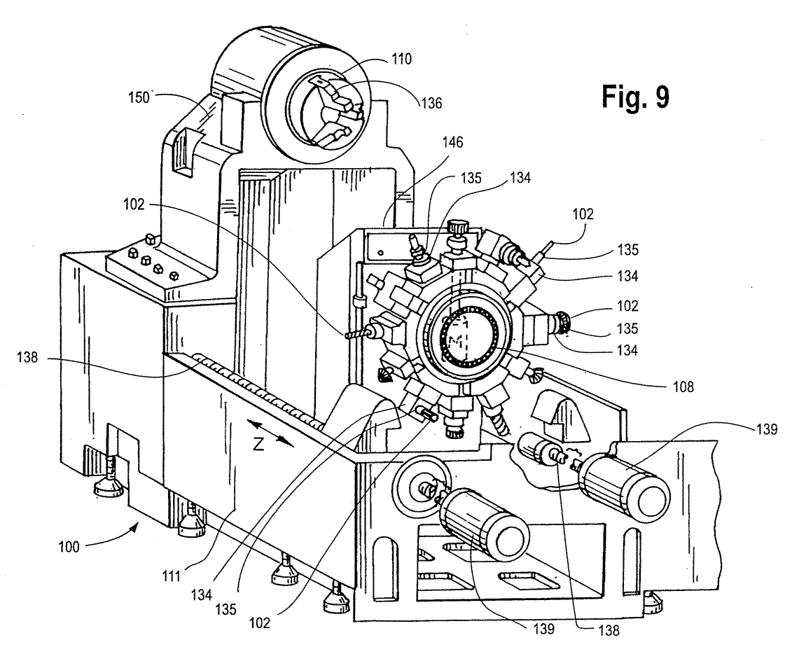

The turret 108, which is best depicted in FIGS. 5, 6 and 9, is mounted in a turret stock 146 (FIG. 5) that also engages rails 138 and that may be translated in a Z-direction, again via ball-screw devices. The turret 108 is provided with various turret connectors 134, as illustrated in FIG. 9. Each turret connector 134 can be connected to a tool holder 135 or other connection for connecting to a cutting tool. Since the turret 108 can have a variety of turret connectors 134 and tool holders 135, a variety of different cutting tools can be held and operated by the turret 108. The turret 108 may be rotated in a C axis to present different ones of the tool holders (and hence, in many embodiments, different tools) to a workpiece.

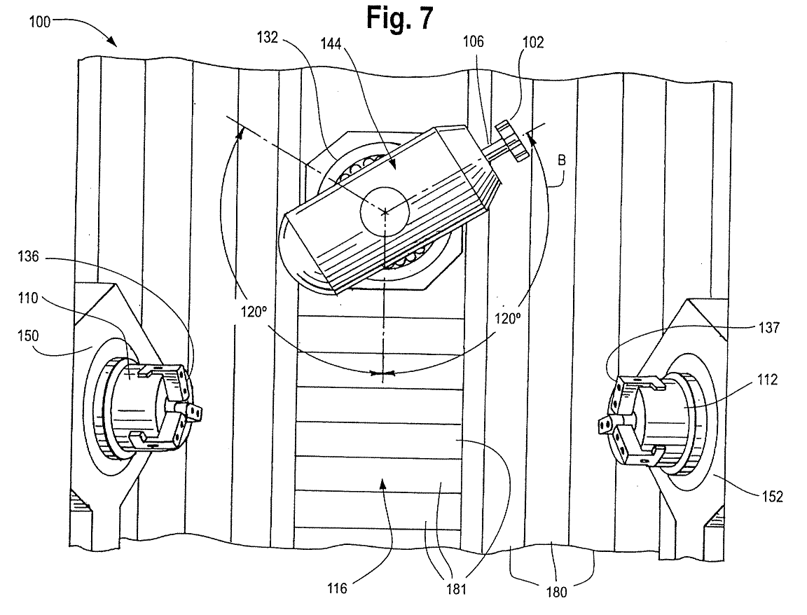

It is thus seen that a wide range of versatile operations may be performed. With reference to tool 102 held in tool holder 106, such tool 102 may be brought to bear against a workpiece (not shown) held by one or both of chucks 110, 112. When it is necessary or desirable to change the tool 102, a replacement tool 102 may be retrieved from the tool magazine 142 by means of the tool changing device 143. With reference to FIGS. 4 and 5, the spindle 144 may be translated in the X and Z directions (shown in FIG. 4) and Y direction (shown in FIGS. 5 and 6). Rotation in the B axis is depicted in FIG. 7, the illustrated embodiment permitting rotation within a range of 120° to either side of the vertical. Movement in the Y direction and rotation in the B axis are powered by motors (not shown) that are located behind the carriage 124. Generally, as seen in FIGS. 2 and 7, the machine is provided with a plurality of vertically disposed leaves 180 and horizontal disposed leaves 181 to define a wall of the chamber 116 and to prevent swarf from exiting this chamber.

The components of the machine 100 are not limited to the heretofore described components. For instance, in some instances an additional turret may be provided. In other instances, additional chucks and/or spindles may be provided. Generally, the machine is provided with one or more mechanisms for introducing a cooling liquid into the chamber 116.

In the illustrated embodiment, the computer numerically controlled machine 100 is provided with numerous retainers. Chuck 110 in combination with jaws 136 forms a retainer, as does chuck 112 in combination with jaws 137. In many instances these retainers will also be used to hold a workpiece. For instance, the chucks and associated stocks will function in a lathe-like manner as the headstock and optional tailstock for a rotating workpiece. Spindle 144 and spindle connection 145 form another retainer. Similarly, the turret 108, when equipped with plural turret connectors 134, provides a plurality of retainers (shown in FIG. 9).

The computer numerically controlled machine 100 may use any of a number of different types of cutting tools known in the art or otherwise found to be suitable. For instance, the cutting tool 102 may be a milling tool, a drilling tool, a grinding tool, a blade tool, a broaching tool, a turning tool, or any other type of cutting tool deemed appropriate in connection with a computer numerically controlled machine 100. As discussed above, the computer numerically controlled machine 100 may be provided with more than one type of cutting tool, and via the mechanisms of the tool changing device 143 and magazine 142, the spindle 144 may be caused to exchange one tool for another. Similarly, the turret 108 may be provided with one or more cutting tools 102, and the operator may switch between cutting tools 102 by causing rotation of the turret 108 to bring a new turret connector 134 into the appropriate position.

Other features of a computer numerically controlled machine include, for instance, an air blower for clearance and removal of chips, various cameras, tool calibrating devices, probes, probe receivers, and lighting features. The computer numerically controlled machine illustrated in FIGS. 1-9 is not the only machine of the invention, but to the contrary, other embodiments are envisioned.

In some embodiments, the computer numerically controlled machine 100 as described hereinabove may be used in a method for removing material from a cutting tool 102 in a dressing or grinding operation. Grinding (sometimes referred to as “regrinding”) of a cutting tool implies removal of material from a cutting tool in a larger amount relative to dressing of the cutting tool, while dressing of the cutting tool implies removing a relatively smaller amount of material. Generally, but not always, dressing is performed at more frequent intervals than grinding.

In one of the methods described herein, a cutting tool 102 is provided, the cutting tool 102 being operatively coupled to one of the retainers in a computer numerically controlled machine 100. In accordance with the present invention, a “cutting tool” is deemed to include tools with a defined cutting edge that is distinct from the undefined edge of a grinding tool. The cutting tool is placed into contact with a least one workpiece to cause removal of material from the at least one workpiece in a cutting operation. An abrasive surface is operatively coupled to a second retainer, and the first retainer is moved relative to the second retainer to cause the cutting tool to come into contact with the abrasive surface, whereby the abrasive surface abrades material from the cutting tool to dress or grind the cutting tool. It is contemplated that the workpiece may be removed from the machine prior to grinding or dressing the cutting tool. In some embodiments, however, a tool may be redressed or reground after each cutting step, even during processing of a single workpiece. Grinding of a portion of a cutting tool during a cutting operation also is contemplated. In such embodiment, the grinding wheel is removing material from the cutting tool at the same time the tool is cutting a workpiece.

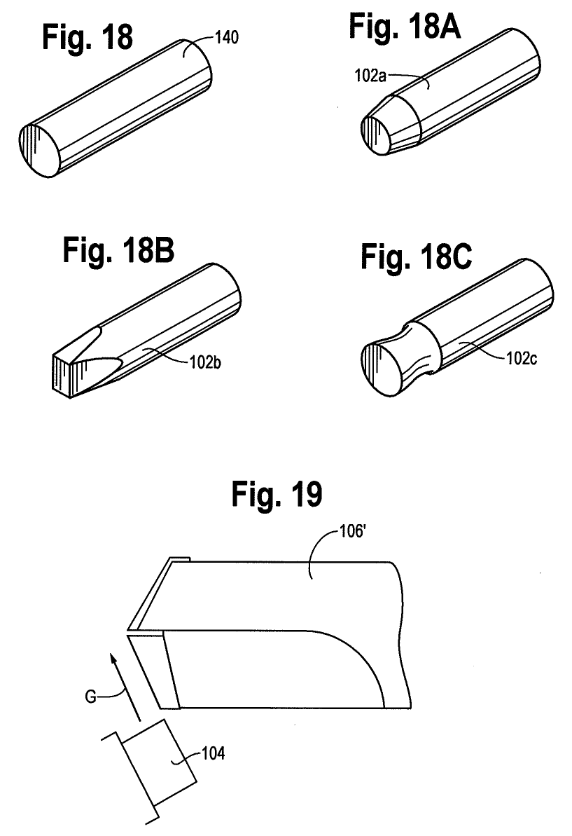

In another operation, a method for forming a cutting tool includes providing a tool blank, the tool blank being operatively coupled to a first retainer, providing an abrasive surface, the abrasive surface being operatively coupled to a second retainer, and moving the first and second retainers relative to one another to cause the abrasive surface to abrade material from the tool blank to thereby form a cutting tool. It is contemplated that a cutting tool may be operatively coupled to a retainer of the machine and placed into contact with a workpiece to cause removal of material from the workpiece in a cutting operation. The cutting tool used in the cutting operation may be the cutting tool formed via abrasion of material from a tool blank. As illustrated in FIGS. 18 and 18 A-C, for instance, tool blank 140 may be used to prepare any one of tools 102A, 102B, 102C. In some embodiments a cutting tool is formed from a blank after a different cutting tool is used to remove material from a workpiece.

The location of the cutting tool (or tool blank) and the abrasive surface on the various retainers in the computer numerically controlled machine 100 is not deemed to be critical, and, to the contrary, it is contemplated that the abrasive surface may be retained on a tool retainer of the spindle 144, the first chuck 110, the second chuck 112, or on tool connector of the turret 108. Similarly, the cutting tool or tool blank can be disposed on the spindle connectors of the spindle 144, the first or second chuck 110, 112, or turret connection 134 of the turret 108. In some embodiments, the abrasive surface may be disposed on a circumference 182 of one of the chucks 110, for instance, as illustrated in FIG. 12. The abrasive surface illustrated in FIG. 12 is a ring-shaped abrasive surface 107 having a generally annular configuration, and is held in place via radial forces imparted by the jaws 136. It is contemplated that the abrasive wheel 107 might be secured adhesively or otherwise to a circumferential surface 182 of the chuck 110, and it is likewise contemplated that the abrasive wheel 107 need not take the form of a continuous ring; for instance, it may take the form of discrete abrasive pieces. The abrasive wheel 107 may be coupled to the designated retainer before commencing an operation in the machine 100 (for instance, it may be disposed on an unused facet of the turret 108) or may be coupled to the retainer at the conclusion of a machine operation. In some embodiments, the abrasive surface may take the form of a wheel or other shape connected to two tool connectors. The abrasive surface thereby may be contained in the tool magazine 142, coupled to the spindle 144, and passed to another retainer of the machine 100.

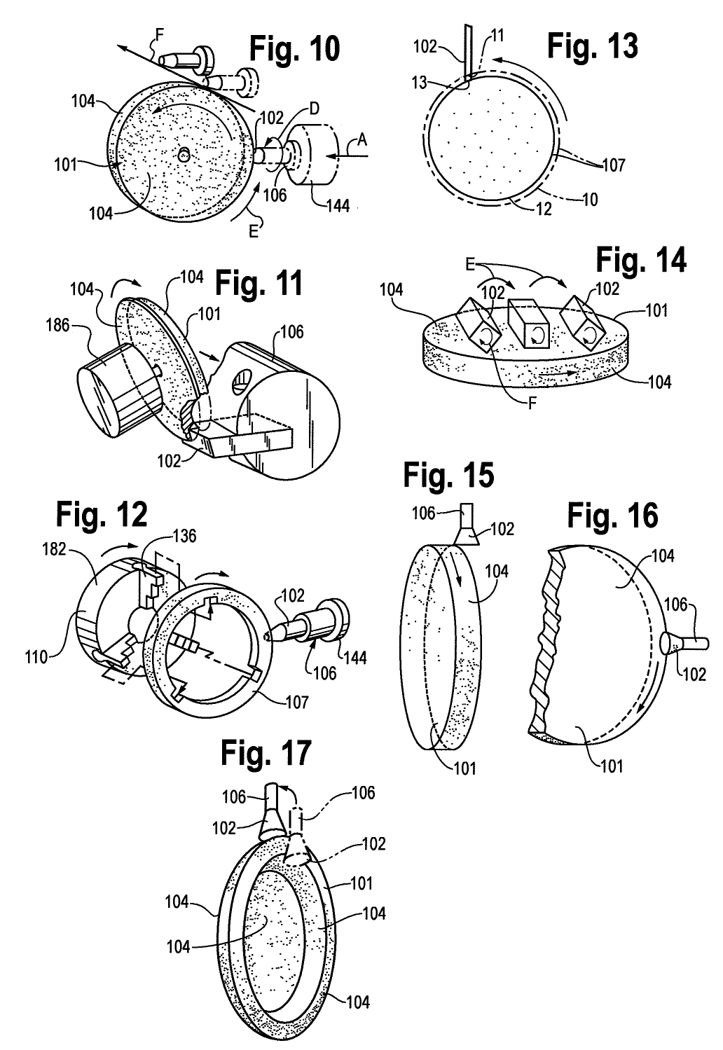

Thus, for instance, with reference to FIG. 10, the abrasive surface 104 is illustrated as being disposed on a grinding wheel 101 of the computer numerically controlled machine. The cutting tool 102, disposed on a spindle 144, is brought into contact with the abrasive surface 104 in a grinding or dressing operation. The path of the tool 102 relative to the axis of rotation of the grinding wheel 101 is illustrated with reference to arrow F. As seen, various surfaces of the tool 102 are brought into contract with the grinding wheel at various positions along the path of movement. During grinding, the wheel 101 may be rotated in the direction of arrow E, and the tool 102 may be rotated in the direction of arrow D. A different grinding operation is depicted in FIG. 11, where the grinding wheel 101 is also mounted on a retainer 186, such as a turret connection or a spindle connection. In another example, FIG. 14 illustrates a virtual lobbing tool path, indicated by arrows E, created by a combination of rotation of the tool 102 and a synchronized linear move against the grinding wheel 101 with the tool 102.

With reference to FIGS. 12 and 13, the arrangement of the annular grinding surface 107 is coaxial and concentric with the chuck 110, which addresses variation in the temperature of the machine and errors caused thereby. Specifically, variation in the temperature of the machine may result in growth and thermal deformation of various parts per a coefficient of thermal expansion in the materials used to construct the machine. When the grinding wheel 107 is concentric with the chuck, thermal growth is addressed. For instance, if the dressing cycle were programmed to remove ten microns of material from the tool, and if the machine tool growth resulted in two microns of displacement from the central line of the work, the radius machined would normally increase by two microns. If such tool were brought to bear on a rotating workpiece, the diameter of the work would decrease by four microns. When the dressing cycle is performed after thermal expansion, the additional material would result in eight, rather than ten, microns of material removed from the cutting tool. Subsequent work would be machined to the correct diameter.

Likewise, as illustrated in FIG. 13, errors resulting from reduction in size of the grinding wheel 107 may be mitigated. The grinding wheel 107 has an intended diameter 10. The wheel is used to grind geometry 11 of the tool 102. If the wheel has been reduced to a smaller diameter 12, a tool geometry 13 would be produced of the wrong size, but without compromise in land or radius. The proposed tool geometry and methods are insensitive to errors due to the reduction in grinding wheel size, because the same portion of the grinding wheel is used to grind the various faces of the cutting tool.

FIGS. 15 and 16 illustrate the abrading of a positive round tool 102 using a disc-shaped grinding wheel 101. FIG. 17 illustrates the abrading of a positive round tool 102 using a pie-plate shaped grinding wheel 101. The grinding wheel 101 of FIG. 17 may be useful in connection with tools having more complex or irregular geometries. It is understood that these examples are not intended to be an exclusive or exhaustive list.

The disclosed methods can be easily applied for specific geometries of the cutting tools, such as that illustrated, for example, in FIG. 19. In the tool 102 shown in FIG. 19, the abrasive surface 104 moves in direction G to grind a drill tool.

It is thus seen that a computer numerically controlled machine may be used to dress or grind tools, or may be used to prepare tools from tool blanks.

All references, including publications, patent applications, and patents, cited herein are hereby incorporated by reference. Any description of certain embodiments as “preferred” embodiments, and other recitation of embodiments, features, or ranges as being preferred, is not deemed to be limiting, and the invention is deemed to encompass embodiments that are presently deemed to be less preferred. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention.

What is claimed is:

1. A method for removing material from a cutting tool in a dressing or grinding operation, the method comprising, in any suitable order:
providing a computer numerically controlled machine having at least a first and second a retainer, each of said first and second retainers comprising one of a spindle retainer, a turret retainer, a first chuck and a second chuck, and a computer control system operatively coupled to said first retainer and to said second retainer;
providing a cutting tool, said cutting tool being operatively coupled to said first retainer;
placing said cutting tool into contact with at least one workpiece to cause removal of material from said at least one workpiece in a cutting operation;
providing an abrasive surface operatively coupled to said second retainer;
moving said first retainer relative to said second retainer to cause said cutting tool to come into contact with said abrasive surface whereby said abrasive surface abrades material from said cutting tool to dress or grind said cutting tool.

2-16. (canceled)

17. A method for forming a cutting tool comprising:
providing a computer numerically controlled machine having a least first and second retainer, each of said first and second retainers comprising one of a spindle retainer, a turret retainer, a first chuck and a second chuck, and a computer control system operatively coupled to said first retainer and to said second retainer;
providing a cutting tool, said cutting tool being operatively coupled to a retainer of said computer numerically controlled machine;
placing said cutting tool into contact with at least one workpiece to cause removal of material from said at least one workpiece in a cutting operation;
providing a tool blank, said tool blank being operatively coupled to said first retainer;
providing an abrasive surface, said abrasive surface being operatively coupled to said second retainer;
moving said first and second retainers relative to one another to cause said abrasive surface to abrade material from said tool blank to thereby form a cutting tool.

18-27. (canceled)

28. A computer numerically controlled machine comprising:
at least first and second retainers, each of said first and second retainer comprising one of a spindle retainer, a turret retainer, a first chuck, and a second chuck;
at least one cutting tool, said at least one cutting tool being operatively connected to said first retainer;
an abrasive surface, said abrasive surface being operatively coupled to said second retainer;
a computer control system operatively coupled to said first retainer and to said second retainer and causing said first retainer to move relative to said second retainer, said computer control system including a computer readable medium having disposed thereon code for causing said first retainer to move relative to a workpiece to cause said cutting tool to remove materials from said work piece and code for causing said first retainer to move relative to said second retainer to cause said abrasive surface to come into contact with said cutting tool and to abrade said cutting tool in a grinding or dressing operation.

29-40. (canceled)

41. A computer numerically controlled machine comprising:
at least first and second retainers, each of said first and second retainers being one of a spindle retainer, a turret retainer, a first chuck, and a second chuck;
at least one cutting tool blank, said cutting tool blank being operatively coupled to said first retainer;
an abrasive surface, said abrasive surface being operatively coupled to said second retainer;
a computer control system operatively coupled to said first and second retainers, said computer control system including a computer readable medium including code for causing a cutting tool to move relative to a workpiece to cause said cutting tool to remove material from said work piece; and code for causing said first retainer to move relative to said second retainer to cause said abrasive surface to abrade material from said tool blank to thereby form a cutting tool.

42-54. (canceled)

55. A method comprising:
providing a computer numerically controlled machine having a least first and second retainer, each of said first and second retainers comprising one of a spindle retainer, a turret retainer, a first chuck and a second chuck, and a computer control system operatively coupled to said first retainer and to said second retainer;
providing a tool blank, said tool blank being operatively coupled to said first retainer;
providing an abrasive surface, said abrasive surface being operatively coupled to said second retainer;
moving said first and second retainers relative to one another to cause said abrasive surface to abrade material from said tool blank to thereby form a cutting tool; and
cutting a workpiece with said cutting tool in said computer numerically controlled machine after forming said cutting tool.

56. A method for removing material from a cutting tool in a dressing or grinding operation, the method comprising, in any suitable order:
providing a computer numerically controlled machine having at least a first and second a retainer, each of said first and second retainers comprising one of a spindle retainer, a turret retainer, a first chuck and a second chuck, and a computer control system operatively coupled to said first retainer and to said second retainer;
providing a cutting tool, said cutting tool being operatively coupled to said first retainer;
placing said cutting tool into contact with at least one workpiece to cause removal of material from said at least one workpiece in a cutting operation;
providing an abrasive surface operatively coupled to said second retainer;
moving said first retainer relative to said second retainer to cause said cutting tool to come into contact with said abrasive surface whereby said abrasive surface abrades material from said cutting tool to dress or grind said cutting tool while said cutting tool is removing material from said workpiece.
